(19) United States
(12) Patent Application Publication
(10) Pub. No.: US 2010/0113715 A1
(43) Pub. Date: May 6, 2010

(54) Olefin polymerization process

(76) Inventor: Michael W. Lynch, West Chester, OH (US)

Correspondence Address: LyondellBasell Industries, 3801 WEST CHESTER PIKE, NEWTOWN SQUARE, PA, 19073, US

(21) Appl. No.: 12/290,792

(22) Filed: Nov. 4, 2008

(51) Int. Cl. C08G 81/02

(52) U.S. Cl. 526/65

(57) ABSTRACT

A multi-reactor solution process for polymerizing ethylene is disclosed. Ethylene is polymerized in a first reaction zone in two parallel reactors and the polyethylene is transferred to a second reaction zone to continue or complete the polymerization. Ethylene is contacted with a mixture of a titanium halide and a vanadium halide in the first parallel reactor and with a magnesium-titanium based Ziegler-Natta catalyst at a lower temperature in the second parallel reactor. The process gives improved catalyst activity.

### FIELD OF THE INVENTION

The invention relates to a multi-reactor solution process for polymerizing ethylene. The process uses a combination of Ziegler-Natta catalysts in two parallel reactors in a first reaction zone and provides high catalyst activity.

### BACKGROUND OF THE INVENTION

Ziegler-Natta catalysts are a mainstay for polyolefin manufacture. Typically, Ziegler-Natta catalysts are based upon titanium compounds such as titanium tetrachloride. A cocatalyst is generally used. Cocatalysts are typically aluminum compounds such as triethyl aluminum or diethyl aluminum chloride. Much research has been done since their inception and there are many types of Ziegler-Natta catalysts. Combinations of titanium compounds with vanadium compounds have long been used as Ziegler-Natta catalysts (see for example, Canadian Pat. No. 635,823 and U.S. Pat. No. 3,218,266). For example, a combination of titanium tetrachloride with a vanadium chloride such as vanadium oxychloride provides a catalyst having good thermal stability making it suitable for the high temperatures required in a solution process for polymerizing ethylene.

Magnesium-titanium based Ziegler-Natta catalysts are also known. They can be prepared by the treatment of an alkyl magnesium compound with a titanium halide. For example, U.S. Pat. No. 5,589,555 uses a catalyst prepared from titanium tetrachloride and dibutyl magnesium in a solution polymerization of ethylene. A highly active magnesium-titanium based catalyst is made from alkyl magnesium silylamides and titanium tetrachloride (U.S. Pat. No. 4,499,198).

For examples of solution processes, see U.S. Pat. Nos. 3,218,266, 5,236,998, 6,127,484, 6,221,985, and 6,756,455. In a solution process, the polyethylene is prepared in a hydrocarbon solution. The requisite high temperatures tend to deactivate the catalyst. Many catalysts are ineffective in this process and even the most effective catalysts must be used at high concentrations. The high concentrations used require that the catalyst be removed or deactivated for most polyethylene applications.

Various reactor configurations have been used. U.S. Pat. No. 5,236,998 uses a mixture of vanadium oxychloride and titanium tetrachloride in two parallel reactors in a first reaction zone and combines the streams into a subsequent reactor. The comonomer is concentrated in the higher molecular weight fraction. U.S. Pat. No. 6,127,484 uses a parallel multiple reactor process with a single-site catalyst in one parallel reactor and a Ziegler-Natta catalyst in the second parallel reactor.

Despite substantial research in the area, further improvements are needed. Most catalysts that are effective at comonomer incorporation have poor thermal stability and are therefore easily deactivated. Decreasing the reaction temperature often decreases the overall rate of polyethylene production. Other catalysts decrease in activity at lower temperatures. A solution process with increased catalyst activity would be valuable.

### SUMMARY OF THE INVENTION

The invention is multi-reactor solution process for polymerizing ethylene. Ethylene polymerizes in a first reaction zone in two parallel reactors, and the resulting polyethylene is transferred to a second reaction zone to continue or complete the polymerization. Ethylene is contacted with a mixture of a titanium halide and a vanadium halide in the first parallel reactor. Additional ethylene is contacted with a magnesium-titanium based Ziegler-Natta catalyst in the second parallel reactor. We surprisingly found that process productivity can be improved by selecting reactor configuration, temperature, and catalysts.

### DETAILED DESCRIPTION OF THE INVENTION

The invention is multi-reactor solution process for polymerizing ethylene. By a “solution process,” we mean that the temperature and pressure in the reactor are high enough that the monomer (i.e., ethylene and any α-olefin) and any reaction solvent are primarily in a single fluid phase. The reactor temperature is kept above the melting point of the polyethylene product. For examples of a typical solution process, see U.S. Pat. No. 5,236,998, the teachings of which are incorporated herein by reference.

Preferably, the pressure is from 1 MPa to 35 MPa, more preferably from 5 MPa to 25 MPa. Preferably, the optional solvent is a saturated hydrocarbon. Preferably, the boiling point of the solvent is within the range of 30° C. to 150° C. Solvents with lower boiling points can create excess pressure while solvents with higher boiling points can be difficult to remove at the end of the process. Suitable solvents include C₅ to C₁₂ hydrocarbon isomers, including cyclic compounds, and mixtures thereof.

The reactors can be any suitable equipment such as combinations of continuous stirred tank reactors (CSTRs) or tubular reactors. Preferably, the last reaction zone is a plug-flow tubular reactor (also called a “non-back-mixed” tubular reactor). Preferably, the process is continuous.

The process comprises polymerizing ethylene in a first reaction zone (also called “Zone 1”) in two parallel reactors. Ethylene and any solvent are fed into each of the two parallel reactors. A different catalyst is fed to each of the two parallel reactors. Preferably, an α-olefin comonomer is also fed to one or both parallel reactors. Preferred α-olefins are propylene, 1-butene, 1-hexene, and 1-octene. More preferred are 1-hexene and 1-octene. When an α-olefin is used, preferably greater than 60% by weight of the α-olefin is added to the second parallel reactor because the magnesium-titanium based Ziegler-Natta catalyst is particularly effective at comonomer incorporation. More preferably, greater than 75% and most preferably, greater than 95% of the α-olefin is added to the second parallel reactor.

A different catalyst is fed to each of the two parallel reactors. A mixture of a titanium halide and a vanadium halide is fed to the first parallel reactor. The titanium halide and vanadium halide can be premixed and fed to the first parallel reactor or each may be fed to the first parallel reactor independently. Suitable titanium halides include, e.g., titanium trichloride and titanium tetrachloride. Titanium tetrachloride is preferred. Suitable vanadium halides include, e.g., vanadium tetrachloride and vanadium oxytrichloride. For additional examples of suitable titanium halides and vanadium halides, see U.S. Pat. Nos. 3,218,266; 3,257,332; 4,250,288; and 4,371,455, the teachings of which are incorporated herein by reference. See also Canadian Pat. No. 635,923. Preferably, the molar ratio of vanadium halide to titanium halide is from 0.5:1 to 10:1, more preferably from 1.5:1 to 5:1.

Preferably, an aluminum compound is added as a cocatalyst. Preferably, the aluminum compound is a trialkyl aluminum compound such as triethyl aluminum or tri-isobutyl aluminum, a dialkyl aluminum halide such as diethyl aluminum chloride, an alkyl aluminum dihalide such as butyl aluminum dichloride, a dialkyl aluminum alkoxide such as diethyl aluminum ethoxide, a dialkyl aluminum siloxide such as dibutyl aluminum trimethyl siloxide, or a tetraalkyl aluminum oxide such as bis(diisobutylaluminum)oxide. Trialkyl aluminum compounds are more preferred. Preferably, the molar ratio of the aluminum compound to transition metal is within the range of 0.5:1 to 50:1, more preferably from 1:1 to 5:1.

The temperature of the reactors can be controlled by several methods such as by adjusting the temperature of the feed streams, ethylene concentration, or catalyst concentration. Preferably, the temperature of the first parallel reactor is from 125° C. to 255° C., more preferably, from 150° C. to 220° C.

A second catalyst is added to the second parallel reactor. This second catalyst is a magnesium-titanium based Ziegler-Natta catalyst. The magnesium-titanium Ziegler-Natta catalyst has good activity at high temperatures and surprisingly increases in activity as the reaction temperature is decreased. Preferably, the second catalyst is formed by contacting a titanium compound with a magnesium compound. Preferably, the magnesium compound is a magnesium halide (e.g., magnesium chloride) or an organomagnesium compound. More preferably, the second catalyst is formed by contacting a titanium compound with an organomagnesium compound. Preferably, the titanium compound is titanium tetrachloride and the organomagnesium compound is an alkyl magnesium compound such as ethyl magnesium chloride or dibutyl magnesium. Preferably, the alkyl magnesium compound is an alkyl magnesium silylamide. Alkyl magnesium silylamides suitable for use in this process are described in U.S. Pat. No. 4,499,198, the teachings of which are incorporated herein by reference. Other suitable magnesium-titanium based Ziegler-Natta catalysts are described in U.S. Pat. Nos. 3,989,881; 4,303,771; 4,707,530; 5,300,470; and 5,589,555, the teachings of which are incorporated herein by reference.

Preferably, an aluminum compound is added as a cocatalyst to the second reactor. It can be the same or a different aluminum compound as added to the first parallel reactor.

The temperature of the second parallel reactor is lower than that of the first parallel reactor. Preferably, the temperature of the second parallel reactor is from 115° C. to 220° C., more preferably from 140° C. to 200° C. Preferably, the temperature in the second parallel reactor is at least 2° C. less, more preferably at least 5° C. less, than the temperature of the first parallel reactor. Surprisingly, I found that reducing the temperature in the second parallel reactor actually increases catalyst activity (see Table 1). Usually, activity increases with increasing temperature, but with a magnesium-titanium catalyst in the second parallel reactor, the opposite is true. Moreover, the activity increase is substantial: dropping the temperature about 17° C. in the second parallel reactor increased overall catalyst activity by 25% while maintaining a consistent production rate.

The product from each of the parallel reactors is fed to a second reaction zone (also called “Zone 2”). Optionally, ethylene, an α-olefin comonomer, hydrogen, and catalyst are also fed to Zone 2. Preferably, all of the α-olefin comonomer is added in Zone 1 and none is added to Zone 2 or subsequent reaction zones. Preferably, ethylene and the same catalyst as used in the first parallel reactor are added to Zone 2. Preferably, the temperature of Zone 2 is higher than the temperature of the first parallel reactor. Preferably, the temperature of Zone 2 is from 150° C. to 320° C., more preferably from 170° C. to 280° C. Zone 2 can include one or more reactors. Preferably, a single reactor is used. Optionally, there can be more than two reaction zones. Preferably, the temperature of each reaction zone is higher than that of the preceding zone. The reactors can be any suitable equipment such as combinations of continuous stirred tank reactors or tubular reactors. Preferably, the last reaction zone is a plug-flow tubular reactor.

Optionally, chain transfer agents are added to one or more of the reactors to control molecular weight. Hydrogen is a preferred chain transfer agent. The amount of hydrogen used in any reactor can be varied. When an α-olefin is used, preferably greater than 60% by weight of the α-olefin is added to the second parallel reactor and more hydrogen is added to the first parallel reactor than to the second parallel reactor. By adjusting hydrogen flows in this manner, comonomer can be incorporated into the high molecular weight portion of the overall molecular weight distribution.

The following examples merely illustrate the invention. Those skilled in the art will recognize many variations that are within the spirit of the invention and scope of the claims.

### Effect of Temperature on Activity

### Study A

Single reactor solution polymerizations of ethylene with 1-octene in the presence of hydrogen are performed at varying temperatures using a magnesium-titanium based Ziegler-Natta catalyst prepared by the reaction of butyl magnesium bis(trimethylsilyl)amide with titanium tetrachloride as described in U.S. Pat. No. 4,499,198. Triethyl aluminum is used as a cocatalyst. Multiple polymerizations are conducted at each temperature, and catalyst activities are measured and averaged.

At 180° C., the activity is 4800 g polyethylene per g catalyst. At 170, 160, and 140° C., the activities are, respectively, 6700, 7200, and 9900 g PE/g cat.

These results show that the magnesium-titanium based Ziegler-Natta catalyst has good activity at high temperature and surprisingly, the activity increases as temperature decreases.

### Study B

In similar fashion as in Study A, single-reactor polymerizations are performed using a magnesium-titanium based Ziegler-Natta catalyst prepared from magnesium chloride as described in U.S. Pat. No. 5,300,470. At 180° C., the activity is 2400 g PE/g cat., and at 140° C., the activity is 3400 g PE/g cat.

These results show that other magnesium-titanium based Ziegler-Natta catalysts have good activity at high temperature and that the activity increases as temperature decreases.

### Study C

In similar fashion as in Study A, single-reactor polymerizations are performed using a 4:1 molar ratio of vanadium oxytrichloride and titanium tetrachloride. As the temperature decreases from 180° C. to 140° C., a 35% decrease in catalyst activity is observed.

These results show that the activity increase observed with the magnesium-titanium based Ziegler-Natta catalysts is unexpected and not typical for Ziegler-Natta catalysts.

### EXAMPLE 1

### Ethylene Polymerization

A multi-reactor solution polymerization of ethylene is performed. The polymerization is performed in three reaction zones. In the first reaction zone, 153,000 pounds per hour of hexane solvent heated to 70° C. and containing 10% by weight ethylene is continuously added to two parallel continuously stirred tank reactors.

The temperature of the first parallel reactor is maintained at 178° C. by adjusting the flow of catalyst. The catalyst added to the first parallel reactor is a mixture of vanadium oxytrichloride and titanium tetrachloride in a 4:1 molar ratio. The catalyst is added at a rate of 1.9 pounds per hour. Triethyl aluminum (2.5 pounds per hour) and hydrogen (3.1 pounds per hour) are also added to the first parallel reactor.

The temperature of the second parallel reactor is maintained at 170° C. by adjusting the flow of catalyst. The catalyst added to the second parallel reactor is a magnesium-titanium based Ziegler-Natta catalyst prepared by the reaction of butyl magnesium bis(trimethylsilyl)amide with titanium tetrachloride as described in U.S. Pat. No. 4,499,198. The catalyst is added at a rate of 8.6 pounds per hour. Triethyl aluminum (11.2 pounds per hour), hydrogen (4.8 pounds per hour), and 1-octene (4,800 pounds per hour) are also added to the second parallel reactor.

The flows from each of the parallel reactors are transferred to a continuously stirred tank reactor in a second reaction zone. Hexane solvent containing 37% by weight ethylene (38,500 per hour), hydrogen (0.5 pounds per hour), triethyl aluminum (6 pounds per hour) and a mixture of vanadium oxytrichloride and titanium tetrachloride (4.6 pounds per hour in a 4:1 molar ratio) are also added to this reactor. The reactor temperature is maintained at 242° C.

The flow from the second reaction zone is sent to a plug flow tubular reactor (third reaction zone). Polyethylene is isolated from the exit of the tubular reactor at a rate of 46,200 pounds per hour. The catalyst activity is calculated to be 3,000 pounds polyethylene per pound based on the combined amounts of catalyst.

### EXAMPLE 2

### Ethylene Polymerization

A multi-reactor solution polymerization of ethylene is performed in similar fashion as in Example 1, but at lower reaction temperatures in the two parallel reactors in Zone 1. Polyethylene is isolated from the exit of the tubular reactor at a rate of 46,100 pounds per hour. The catalyst activity is 3500 pounds polyethylene per pound based on the combined amounts of catalyst.

### COMPARATIVE EXAMPLE 3

### Ethylene Polymerization

A multi-reactor solution polymerization of ethylene is performed in similar fashion as in Example 1, but using similar reaction temperatures in the two parallel reactors in Zone 1 and using a mixture of vanadium oxytrichloride and titanium tetrachloride in a 4:1 molar ratio as the catalyst added to each of the reactors. Polyethylene is isolated from the exit of the tubular reactor at a rate of 46,100 pounds per hour. The catalyst activity is 2800 pounds polyethylene per pound based on the combined amounts of catalyst.

TABLE 1
Polymerizations

| | Parallel | | Parallel | | Zone 2 | | Catalyst |
|---|---|---|---|---|---|---|---|
| | Reactor 1 | | Reactor 2 | | Reactor | | activity |
| | Temp | lb. | Temp | lb. | Temp | lb. | (lb. PE/ |
| Ex. | (° C.) | cat/h | (° C.) | cat/h | (° C.) | cat/h | lb. cat) |
| 1 | 177.8 | 1.9 | 169.9 | 8.6 | 242.4 | 4.6 | 3,000 |
| 2 | 173.2 | 2.0 | 159.3 | 6.7 | 241.1 | 4.4 | 3,500 |
| C3 | 178.1 | 1.7 | 177.2 | 10.1 | 241.5 | 4.5 | 2,800 |

Examples 1 and 2 demonstrate an improvement in activity over Comparative Example 3 when the process of the invention is used. This improvement is obtained while keeping the overall rate of polyethylene production constant at about 46,000 pounds per hour. Note the reduced amount of catalyst needed for Parallel Reactor 2 in each of Examples 1 and 2 compared with the amount used in Comparative Example 3 to produce the same amount of polyethylene.

The preceding examples are meant only as illustrations. The following claims define the invention.

1. A multi-reactor solution process which comprises polymerizing ethylene in a first reaction zone in first and second parallel reactors and transferring the polyethylene from each reactor to a second reaction zone to continue or complete the polymerization; wherein ethylene is contacted in the first parallel reactor with a first catalyst comprising a mixture of a titanium halide and a vanadium halide and ethylene is contacted in the second parallel reactor with a second catalyst comprising a magnesium-titanium based Ziegler-Natta catalyst and wherein the temperature in the second parallel reactor is lower than the temperature in the first parallel reactor.

2. The process of claim 1 wherein the first catalyst comprises a mixture of titanium tetrachloride and vanadium oxytrichloride.

3. The process of claim 1 wherein the second catalyst comprises the product formed by contacting a titanium compound with a magnesium halide or an organomagnesium compound.

4. The process of claim 3 wherein the second catalyst comprises the product formed by contacting titanium tetrachloride with an alkyl magnesium compound.

5. The process of claim 4 wherein the alkyl magnesium compound is an alkyl magnesium silylamide.

6. The process of claim 1 further comprising the addition of an α-olefin in the first reaction zone.

7. The process of claim 6 wherein greater than 60% by weight of the α-olefin is added to the second parallel reactor and the α-olefin is selected from the group consisting of 1-butene, 1-hexene, and 1-octene.

8. The process of claim 1 wherein the first catalyst is additionally added to the second reaction zone.

9. The process of claim 1 further comprising a third reaction zone wherein the third reaction zone is a tubular reactor.

10. The process of claim 1 wherein an aluminum compound selected from the group consisting of trialkylaluminums, dialkylaluminum halides, dialkylaluminum alkoxides, dialkyl aluminum siloxides, alkylaluminum dihalides, and tetraalkyl aluminum oxides is added to the first and second parallel reactors.

11. The process of claim 1 wherein the temperature in the second parallel reactor is at least 2° C. less than the temperature in the first parallel reactor.
